(19) United States
(12) Patent Application Publication
(10) Pub. No.: US 2025/0059382 A1
(43) Pub. Date: Feb. 20, 2025

(54) CHROMIUM-FREE ANTICORROSIVE COATING COMPOSITION AND ARTICLE MADE THEREFROM

(71) Applicant: GUANGDONG HUARUN PAINTS CO., LTD., Foshan, Guangdong (CN)

(72) Inventors: Kai HE, Foshan, Guangdong (CN); Rong XIONG, Foshan, Guangdong (CN); Xi ZHAO, Foshan, Guangdong (CN); Yu ZHANG, Foshan, Guangdong (CN); Wenbin ZHENG, Shanghai (CN)

(21) Appl. No.: 18/724,040

(22) PCT Filed: Dec. 23, 2022
(86) PCT No.: PCT/CN2022/141584

§ 371 Date: Jun. 25, 2024

(30) Foreign Application Priority Data
Dec. 28, 2021 (CN) 202111630932.0

(51) Int. Cl. C09D 5/08; C08K 3/32; C08K 9/02; C09D 5/03; C09D 7/40; C09D 7/62; C09D 163/00

(52) U.S. Cl. CPC C09D 5/084; C09D 5/038; C09D 7/62; C09D 7/69; C09D 163/00; C08K 2003/324; C08K 2003/327; C08K 9/02; C08K 2201/014

(57) ABSTRACT

The present application is directed to chromium-free anticorrosive coating composition and article made therefrom. The chromium-free anticorrosive coating composition comprises Component A, comprising a film-forming composition, a corrosion inhibiting composition, optional carriers and additional additives, wherein the corrosion inhibiting composition comprises anti-rust particles containing at least one phosphate compound of lithium and having a lithium content of at least 1.0% by weight; and optionally Component B, comprising a curing agent. The chromium-free anticorrosive coating composition according to the present application may be used as a primer or a direct-to-metal coating. The present application further discloses an article, comprising a metal substrate; and a coating formed of the above chromium-free anticorrosive coating composition which is directly applied to the metal substrate.

### TECHNICAL FIELD

The present application relates to an anticorrosive coating composition, and more specifically to a chromium-free anticorrosive coating composition with an excellent anticorrosive performance and an article made therefrom.

### BACKGROUND

Metal corrosion is known as a process in which a metal material is in contact with the surrounding environment and experiences a certain reaction where the material is gradually deteriorated or destroyed. Metal corrosion is a common natural phenomenon, occurring as rust on the surface of steel, white powder on the surface of aluminum products, and so on. In order to prevent metal substrates from being corroded, the substrates can be treated with anticorrosive treatments. Such anticorrosive treatments provide important safeguards that prolong the service life of metal substrates and ensure safety of applications.

It is recognized that hexavalent chromium compounds can provide coatings with very good anticorrosive ability. They are not only effective over a wide range of pH, but also have self-repairing functions, and therefore are considered almost irreplaceable as anticorrosive pigments/fillers. However, hexavalent chromium is toxic. Since the 1920s, there have been records showing that hexavalent chromium is carcinogenic in nature. Previous studies have shown that incidence of nasal cancer and lung cancer in industrial workers who are directly exposed to Cr⁶⁺ compounds has increased significantly. In view of this concern for the environment and for worker safety, the call for gradually reducing or even eliminating the application of hexavalent chromium compounds in anticorrosive coatings has increased.

Therefore, there is need in the coating industry for chromium-free anticorrosive coating compositions.

### SUMMARY

The present application provides a chromium-free anticorrosive coating composition, comprising: Component A, comprising a film-forming composition, a corrosion inhibiting composition, optional carriers and additional additives, wherein the corrosion inhibiting composition comprises anti-rust particles containing at least one phosphate compound of lithium and having a lithium content of at least 1.0% by weight; and optionally Component B, comprising a curing agent. Preferably, the anti-rust particles have a lithium content of at least 5.0% by weight, preferably 7.0% by weight or more. In some embodiments of the present application, the corrosion inhibiting composition further comprises at least one cation exchange silica gel.

The present application also provides an article comprising a metal substrate; and a coating formed of the chromium-free anticorrosive coating composition according to the present application which is directly applied to the metal substrate. Preferably, the metal substrate is one or more selected from steel, iron, aluminum, zinc, copper and alloys thereof.

It was surprisingly discovered by the inventors of the present application that in the formulation of a chromium-free anticorrosive coating composition, the use of a corrosion inhibiting composition comprising anti-rust particles containing at least one phosphate compound of lithium and having a lithium content of at least 1.0% by weight, preferably at least 5.0% by weight, more preferably 7.0% by weight or more allows the paint film formed therefrom to exhibit an excellent water resistance in which said corrosion resistance is demonstrated by the fact that the formed film does not blister after being subjected to soaking in an aqueous environment at 40° C. for 18 days or longer, which was not foreseen prior to the present application. It was further surprisingly discovered by the inventors of the present application that in the formulation of a chromium-free anticorrosive coating composition, the use of a corrosion inhibiting composition comprising anti-rust particles containing at least one phosphate compound of lithium and having a lithium content of at least 1.0% by weight, preferably at least 5.0% by weight, more preferably 7.0% by weight or more and at least one cation exchange silica gel allows the paint film formed therefrom to exhibit not only excellent water resistance in which said water resistance is demonstrated by the fact that the formed film does not blister after being subjected to soaking in an aqueous environment at 40° C. for 18 days or longer and after being subjected to soaking in an aqueous environment at room temperature for 500 hours, but also to exhibit excellent corrosion resistance in which said corrosion resistance is demonstrated by the fact that the formed film has a stripping width of no more than 2 mm on one side after being subjected to a salt spray test according to ASTM B117 or GB/T 1771 for 500 hours or longer.

Without wishing to be bound by any theory, it is speculated that the chromium-free anticorrosive coating composition of the present application can achieve the aforementioned anticorrosive effect for the following reasons.

In the formulation of the chromium-free anticorrosive coating composition of the present application, said corrosion inhibiting composition comprises anti-rust particles containing at least one phosphate compound of lithium and having a lithium content of at least 1.0% by weight, preferably at least 5.0% by weight, more preferably 7.0% by weight or more. In a corrosive environment, the phosphate compound of lithium contained in the coating formed by the above-mentioned anticorrosive coating composition can release and/or leach lithium ions therein, and the dissociated lithium ions act as a cathode inhibitor and react with oxygen, water, and the like in the environment to form a passivation layer so that it may protect a metal substrate from external corrosion. As time passes, the above-described anti-rust particles can continuously replenish the lithium ions consumed by oxygen, water, and the like in the environment due to their significantly greater lithium ion content, allowing for the formation of anticorrosive coatings with longer water resistance. For example, in some embodiments of the present application, the paint film formed from the anticorrosive coating composition according to the present application can be stored in an aqueous environment at 40° C. for a period of 18 days or longer, or even 30 days or longer, or even 50 days without blistering.

In the formulation of the chromium-free anticorrosive coating composition of the present application, the corrosion inhibiting composition further comprises at least one cation exchange silica gel. In a corrosive environment, aggressive ions such as (H+), which penetrate into the coating film, are exchanged with cations, such as calcium ions (Ca²⁺), on the surface of the particles of silica gel, resulting in the release of corresponding cations that subsequently migrate to the interface of the metal substrate and further form a protective film at the interface of the metal substrate. It can thus be seen that the cation exchange silica gel not only adsorbs aggressive ions from the environment, but also forms a protective film at the interface of the metal substrate. Therefore, the corrosion inhibiting composition further comprises at least one cation exchange silica gel as an enhancer to further enhance the anticorrosive effect of anti-rust particles containing at least one phosphate compound of lithium.

In addition, the above-mentioned anti-rust particles containing at least one phosphate compound of lithium contained in said corrosion inhibiting composition can be derived from lithium aluminum phosphate filler, which has the advantage of low cost. In other words, the coating compositions formulated therefrom are cost effective and suitable for general application while maintaining excellent anticorrosive performances.

It was further surprisingly discovered by the inventors of the present application that the chromium-free anticorrosive coating composition according to the present application can be used not only as a primer for wet-to-dry systems but also as a primer for wet-to-wet systems, and that the chromium-free anticorrosive coating composition according to the present application not only does not cause construction problems such as sagging and streaking when used as a primer for wet-to-wet systems, but also achieves excellent corrosion resistance.

The details of one or more embodiments of the present disclosure are set forth in the description below. Other features, objects, and advantages of the present disclosure will be apparent from the description, and from the claims.

### DESCRIPTION OF THE DRAWINGS

FIG. 1 shows photographs of composite coatings forming by coating a primer layer formed from the epoxy-based chromium-free anticorrosive coating composition according to Examples 1-3 of the present application with a water-based polyurethane topcoat after subjecting to soaking in an aqueous environment at 40° C. for 18 days where the coating above the black line is not immersed into water and the coating below the black line is immersed into water.

FIG. 2 shows photographs of composite coatings forming by coating a primer layer formed from the epoxy-based chromium-free anticorrosive coating composition according to Examples 1-3 of the present application with a water-based polyurethane topcoat after subjecting to immerse in an aqueous environment at room temperature for 500 hours where the coating above the black line is not immersed into water and the coating below the black line is immersed into water.

FIG. 3 shows photographs of composite coatings forming by coating a primer layer formed from the epoxy-based chromium-free anticorrosive coating composition according to Examples 4-6 of the present application with a water-based polyurethane topcoat after subjecting to soaking in an aqueous environment at 40° C. for 18 days where the coating above the black line is not immersed into water and the coating below the black line is immersed into water.

FIG. 4 shows photographs of composite coatings forming by coating a primer layer formed from the epoxy-based chromium-free anticorrosive coating composition according to Examples 4-6 of the present application with a water-based polyurethane topcoat after subjecting to immerse in an aqueous environment at room temperature for 500 hours where the coating above the black line is not immersed into water and the coating below the black line is immersed into water.

FIG. 5 shows photographs of composite coatings forming by coating a primer layer formed from the epoxy-based chromium-free anticorrosive coating composition according to Examples 4-6 of the present application with a water-based polyurethane topcoat after being subjected to a salt spray test according to ASTM B117 for 502 hours (upper coatings) and 790 hours (lower coatings).

### DEFINITION

As used herein, “a”, “an”, “the”, “at least one”, and “one or more” are used interchangeably. Thus, for example, a composition that comprises “an” additive can be interpreted to mean that the composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the present disclosure, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The term “anticorrosive coating composition” refers to a coating composition that, when applied to a metal substrate in one or more layers, can form a coating layer that can be exposed to corrosive conditions over a relatively long period, for example, salt spray exposure for three weeks or more without obvious visible deterioration or corrosion.

When used for “chromium-free anticorrosive coating composition”, the term “chromium-free” means that various components of the coating composition and the formulated coating composition do not contain any additional hexavalent chromium ions, preferably do not contain any chromium compounds. When the phrases “does not contain”, “does not contain any”, and so on are used herein, such phrases are not intended to exclude the presence of trace related structures or compounds that may exist as environmental pollutants or due to environmental pollution.

As used herein, the term “anti-rust particles containing at least one phosphate compound of lithium” means that such anti-rust that consist primarily of at least one phosphate compound of lithium, but may additionally comprise other components and/or elements that promote/enhance and/or do not adversely affect the anticorrosive performances of the anti-rust particles.

When used for “anti-rust particles”, the phrase “having a lithium content of at least 1.0% by weight” refers to the lithium content of the anti-rust particles as determined by an XPS elemental analyzer, such as a Thermo XPS elemental analyzer, using anti-rust particles as a test sample. In some embodiments of the present application, said anti-rust particles have a lithium content of at least 5.0% by weight, preferably 7.0% by weight or more.

As used herein, the term “phosphate compound of lithium” refers to a compound comprising a lithium cation as well as a phosphate anion. Such compounds may also be doped with one or more other cations and/or anions, as desired. For example, such phosphate compound of lithium may be doped with fluoride ions, hydroxide ions and/or other anions that do not adversely affect the anticorrosive performance of the phosphate compound of lithium and/or aluminum ions, calcium ions, iron ions, magnesium ions, manganese ions, strontium ions, nickel ions and/or other cations that do not affect the anticorrosive performance of the phosphate compound of lithium.

When used for “phosphate compound of lithium”, the phrase “having releasable and/or leachable lithium ions” means that under corrosive conditions, such as 5% by weight aqueous sodium chloride spray at 35° C. or higher, lithium in the phosphate compound of lithium can be dissociated into lithium ions.

When used for “phosphate compound of lithium”, the phrase “having a spatially stable crystal structure” means that the compound has structural stability, namely a crystal structure that is conducive to intercalation into and deintercalation out of lithium ions and other cations (abbreviated as “intercalation-deintercalation”), and where the crystal structure remains basically stable during the intercalation-deintercalation of lithium ions and other cations without major lattice changes. When the coating formed by the coating composition comprising anti-rust particles containing the phosphate compound of lithium is under certain conditions, especially under corrosive conditions for example, 5% by weight sodium chloride aqueous spray at 35° C. for 600 hours or longer, the phosphate compound of lithium in the coating maintains a spatially stable three-dimensional structure after the dissociation of lithium ions and/or other cations, and the coating does not appear to collapse, develop voids, and the like. The phenomenon of “collapse, voids and the like” on the surface of coating described here may be measured by scanning electron microscope (SEM). The “spatially stable crystal structure”, as an example, may be a triclinic crystal structure.

As used herein, the term “cation-exchange silica gel” refers to amorphous silica on which a cation is adsorbed or attached, said cation being exchangeable with a specific cation e.g., a hydrogen ion.

When used for “chromium-free anticorrosive coating composition”, the term “film-forming composition” refers to a component that may form a non-sticky (i.e. dry or hardened) continuous film on the substrate after it is mixed with other components in the coating composition (such as carriers, additives, fillers, and the like), and the resulting mixture is applied to the substrate and dried, cross-linked or otherwise hardened together with a suitable curing agent as required. The “film-forming composition” mainly includes resin components, but may also include film-forming materials such as inorganic silicates.

When used herein, the term “primer” refers to a coating composition that can be applied to a metal substrate and dried, crosslinked, or otherwise hardened to form a non-sticky continuous film having sufficient adhesion to the surface of substrate.

As used herein, the term “direct-to-metal coating (DTM)” refers to a coating composition that can be applied to a metal substrate and dried, crosslinked, or otherwise hardened to form a non-sticky continuous film that has sufficient adhesion on the surface of substrate, and can withstand long-term outdoor exposure without showing visible and unsatisfactory deterioration. The direct-to-metal coating (DTM) not only functions as a primer, having strong adhesion and corrosion resistance, but also as a topcoat, showing a good appearance and decorative effect. Compared to the process of applying primer and topcoat separately, the direct-to-metal coating (DTM) can reduce construction costs and time.

When used herein, the term “wet-on-wet system” refers to a coating system formed by a “wet-on-wet process” where the wet-on-wet process refers to a coating process in which a second coat of paint is applied before the first coat of paint is dry deeply. In some embodiments of the present application, the anticorrosive coating composition according to the present application can be used as a primer for wet-on-wet systems, which not only does not cause construction problems such as sagging and wrinkling, but also achieves excellent anticorrosive performances.

When used herein, the term “wet-on-dry system” refers to a coating system formed by a “wet-on-dry process” where the wet-to-dry process refers to a coating process in which a second coat of paint is applied after the first coat of paint has dried deeply. In the coating industry, the wet-on-dry process is the most commonly used process for applying multiple layers of coatings and is applicable to most coatings.

The term “comprises”, “comprising”, “contains” and variations thereof do not have a limiting meaning where these terms appear in the description and claims.

The terms “preferred” and “preferably” refer to embodiments of the present disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### DETAILED DESCRIPTION

The present application in one aspect provides a chromium-free anticorrosive coating composition, comprising: Component A, comprising a film-forming composition, a corrosion inhibiting composition, optional carriers and additional additives, wherein the corrosion inhibiting composition comprises anti-rust particles containing at least one phosphate compound of lithium and having a lithium content of at least 1.0% by weight; and optionally Component B, comprising a curing agent. Preferably, the corrosion inhibiting composition further comprises at least one cation exchange silica gel.

As described in the background, the call for gradually reducing or even eliminating the application of hexavalent chromium compounds in anticorrosive coatings has increased. In view of this, in recent years, a lot of research has been conducted to look for alternative anticorrosive pigments/fillers to replace hexavalent chromium compounds. Although many alternative reagents have been proposed, none of them have been shown to be as acceptable in anticorrosive coating applications as hexavalent chromium compounds. The primary goal of selecting anticorrosive pigments/fillers is to formulate coatings that shall meet the water resistance test while satisfying the corrosion resistance standards of ASTMB117 salt spray test, which is a recognized aviation and aerospace industry method. In practice, the conventional chromium-free anticorrosive pigments/fillers such as aluminum tripolyphosphate cannot be formulated to form coating satisfying the above corrosion resistance standards, let alone satisfying the above water resistance test.

As described above, it was surprisingly discovered by the inventors of the present application that in the formulation of a chromium-free anticorrosive coating composition, the corrosion inhibiting composition comprises anti-rust particles containing at least one phosphate compound of lithium and having a lithium content of at least 1.0% by weight, preferably at least 5.0% by weight, more preferably 7.0% by weight or more, which allows the paint film formed therefrom to exhibit an acceptable corrosion resistance and an excellent water resistance in which said water resistance is demonstrated by the fact that the formed film does not blister after being subjected to soaking at an aqueous environment at 40° C. for 18 days or longer.

In embodiments according to the present application, the chromium-free anticorrosive coating composition comprises a corrosion inhibiting composition and the corrosion inhibiting composition comprises anti-rust particles containing at least one phosphate compound of lithium and having a lithium content of at least 1.0% by weight. As mentioned above, anti-rust particles are powderous particles comprising primarily at least one phosphate compound of lithium, wherein the phosphate compound of lithium contained in said anti-rust particles is an important component providing anticorrosive effect. As the name implies, a phosphate compound of lithium refers to a compound comprising a lithium cation as well as a phosphate anion. Such phosphate compound of lithium may also be doped with one or more other cations and/or anions, as desired. For example, such phosphate compound of lithium may be doped with fluoride ions, hydroxide ions and/or other anions that do not adversely affect the anticorrosive properties of the phosphate compound of lithium and/or aluminum ions, calcium ions, iron ions, magnesium ions, manganese ions, strontium ions, nickel ions and/or other cations that do not adversely affect the anticorrosive properties of the phosphate compound of lithium.

It is well known that phosphate compounds of lithium are not a component for the formulation of a coating composition in the coating industry. However, it was surprisingly found by the inventors of the present application that in the formulation of the chromium-free anticorrosive coating composition of the present application, said corrosion inhibiting composition comprises anti-rust particles containing at least one phosphate compound of lithium and having a lithium content of at least 5.0% by weight, which allows the paint film formed therefrom to exhibit excellent water resistance in which said water resistance is demonstrated by the fact that the formed film does not blister after being subjected to soaking in an aqueous environment at 40° C. for 18 days or longer, which was not foreseen prior to the present application. Without being bound by any theory, the inventors of the present application found that in a corrosive environment, the phosphate compound of lithium contained in the coating formed by the above-mentioned anticorrosive coating composition can release and/or leach lithium ions therein, and the dissociated lithium ions act as a cathode inhibitor and react with oxygen, water, and the like in the environment to form a passivation layer so that it may protect a metal substrate from external corrosion. As time passes, the above-described anti-rust particles can continuously replenish the lithium ions consumed by oxygen, water, and the like in the environment due to their significantly greater lithium ion content, allowing for the formation of anticorrosive coatings with longer water resistance. For example, in some embodiments of the present application, the paint film formed from the anticorrosive coating composition according to the present application can be stored in an aqueous environment at 40° C. for a period of 18 days or longer, or even 30 days or longer, or even 50 days without blistering. In other words, the incorporation of anti-rust particles containing at least one phosphate compound of lithium and having a lithium content of at least 5% by weight into the corrosion inhibiting composition of the present application allows the resulting coating to have an acceptable corrosion resistance, in particular, a long-term water resistance.

In embodiments according to the present application, said anti-rust particles have a lithium content of at least 1.0% by weight, said lithium content being determined by XPS elemental analysis. Preferably, said anti-rust particles have a lithium content of at least 5.0% by weight, preferably 5.5% by weight or higher, more preferably 6.0% by weight or higher, still more preferably 6.5% by weight or higher, even more preferably 7.0% by weight or higher, for example 7.5% by weight or higher or 8.0% by weight or higher, but not more than 15.0% by weight, preferably not more than 12% by weight, more preferably not more preferably not more than 10% by weight. If the lithium content of the anti-rust particles is too low, the anticorrosive coating composition formed therefrom cannot form an anticorrosive coating with a longer water resistance; if the lithium content of the anti-rust particles is too high, the anti-rust particles are too active to be suitable for the formulation of the anticorrosive coating composition.

In some embodiments of the present application, the at least one phosphate compound of lithium contained in the anti-rust particles has a spatially stable crystal structure, preferably a triclinic crystal structure, and may keep its basic lattice structure in the process of dissociation of lithium ions. The phosphate compound of lithium having a spatially stable crystal structure is particularly suitable as anticorrosion or anti-rust pigments or fillers. Without being bound by any theory, the inventors believe that in a corrosive environment, for example, 5% by weight sodium chloride aqueous spray at 35° C. for 500 hours or more, the phosphate compound of lithium contained in the coating formed from the above-mentioned anticorrosive coating composition can release and/or leach lithium ions therein, and the dissociated lithium ions act as a cathode inhibitor and react with oxygen, water, and the like in the environment to form a passivation layer that may protect a metal substrate from external corrosion. On the other hand, the lattice structure of the phosphate compound of lithium is basically stable in the process of dissociation of lithium ions and will not collapse, so that the paint film will not lose its adhesion while keeping a certain strength, thereby achieving an anticorrosive effect.

In some embodiments of the present application, said anti-rust particles may further comprise at least one other metal element in addition to the phosphate compound of lithium described above, said at least one other metal element comprising one or more of aluminum, calcium, iron, magnesium, manganese, strontium, and nickel. In some embodiments of the present application, said anti-rust particles may further comprise at least one silicon element in addition to the phosphate compound of lithium described above. The inventors of the present application have found that the presence of the above metal elements of aluminum, calcium, iron, magnesium, manganese, strontium, and nickel, and the silicon element in the anti-rust particles according to the present application can promote or enhance the anticorrosive properties of the phosphate compound of lithium.

Without being bound by any theory, the inventors believe that at least some of the other metal elements for example, aluminum, iron, calcium, magnesium, manganese, and the like present in the anti-rust particles of the present application will be released when the anticorrosive coating of the present application is subjected to corrosive conditions, and that these released free metallic ions can combine with free phosphate radical generated upon dissociation of lithium of the phosphate compound of lithium to form a passivation layer, thereby enhancing the anticorrosive properties of the phosphate compound of lithium. When an aluminum metal element is present in the anti-rust particles, such anti-rust particles can release and/or leach aluminum ions therein, and the dissociated aluminum ions may combine with the lithium ions dissociated above, oxygen, water and the like in the environment to produce a similar anticorrosive effect to that of water-soluble lithium salts on metallic aluminum substrates, i.e., to form insoluble LiₓAl_{y}(OH)_{z}, thereby creating a synergistic anticorrosive effect of the anti-rust particles themselves. In addition, the silicon element, usually in the form of silicate, present in the anti-rust particles can be partially dissociated, and the dissociated SiO₃²⁻ reacts with iron ions originating from the metal substrate at the coating/metal interface to form a protective layer of iron silicate (Fe₂(SiO₃)₃), while the dissociated SiO₃²⁻ can also react with other metal cations such as iron, calcium, magnesium, manganese, etc. originating from the anti-rust particles at the coating/metal interface, thus forming a protective film of calcium silicate (CaSiO₃), iron silicate (Fe₂(SiO₃)₃), manganese silicate (Mn₂SiO₃), and the like at the metal interface. The iron silicate, calcium silicate, iron silicate, manganese silicate, and the like as formed will deposit together to form a composite protective film layer at the metal interface, thereby enhancing the anticorrosive properties of the phosphate compound of lithium.

In some embodiments according to the present application, said anti-rust particles are powders having a micron scale, preferably having a particle size of less than 50 microns, more preferably having a particle size of less than 40 microns, more preferably a particle size of less than 35 microns, even more preferably a particle size of less than 30 microns, and having a particle size of 1 micron or larger.

In some embodiments according to the present application, said anti-rust particles are derived from phosphorus-lithium-aluminum fillers, for example powderous particles of 800 mesh obtainable by grinding the phosphorus-lithium-aluminum fillers.

In addition to the above mentioned phosphate compound of lithium, other metal elements, and silicon element, the anti-rust particles according to the present application may additionally comprise other components that do not adversely affect performances of the anti-rust particles, the anticorrosive coating composition formulated therefrom, and the anticorrosive coating obtained therefrom.

In some embodiments of the present application, the anti-rust particles comprising at least one phosphate compound of lithium are alkaline, having a pH of at least 8.0. Preferably, the anti-rust particles comprising at least one phosphate compound of lithium have a pH in the range of 8.0 to 11.5, more preferably in the range of 8.5 to 11.2. In one embodiment of the present application, the anti-rust particles containing at least one phosphate compound of lithium have a pH in the range of 8.5 to 9.0. In another embodiment of the present application, the anti-rust particles containing at least one phosphate compound of lithium have a pH in the range of 9.0 to 11.2.

The above mentioned anti-rust particles containing at least one phosphate compound of lithium may be any known commercially available product, or may be homemade. In an embodiment according to the present application, the anti-rust particles containing at least one phosphate compound of lithium are obtained by grinding the phosphorus-lithium-aluminum fillers commercially available from Yongxing Materials Co., LTD.

Preferably, the anti-rust particles containing at least one phosphate compound of lithium are present in an amount of 5% by weight or more, preferably 6% by weight or more, but not more than 20% by weight, relative to the total weight of the component A. In a specific embodiment of the present application, the anti-rust particles comprising at least one phosphate compound of lithium are present in an amount of about 5 to 18% by weight, or in an amount of about 5 to 15% by weight, or in an amount of about 5.5 to 10% by weight, or in an amount of about 5.5 to 8% by weight, or in an amount of about 5.5 to 7.5% by weight, relative to the total weight of the component A.

In some embodiments according to the present application, the corrosion inhibiting composition contained in the chromium-free anticorrosive coating composition may further comprise at least one cation-exchange silica gel.

As described above, said cation-exchange silica is an amorphous silica having cations adsorbed or attached thereto and the cation may exchange with a particular cation, such as hydrogen ion. In a corrosive environment, aggressive ions such as (H+), which penetrate into the coating film, are exchanged with cations, such as calcium ions (Ca²⁺), on the surface of the particles of silica gel, resulting in the release of corresponding cations that subsequently migrate to the interface of the metal substrate and further form a protective film at the interface of the metal substrate. It can thus be seen that the cation exchange silica gel not only may adsorb aggressive ions from the environment, but also may form a protective film at the interface of the metal substrate. Without being bound by any theory, the inventors believe that cation-exchange silica gel can form a protective film at the interface between the metal substrate and the coating by the following. In a corrosive condition, a metal substrate such as iron is oxidized to ferrous ions (Fe²⁺) in an anodic zone and then further oxidized to ferric ions (Fe³⁺); at the same time, oxygen (O₂) and water (H₂O) in the air can penetrate through the resulting coating to the interface between the coating and the metal substrate and be reduced to hydroxide ions, which is known as a cathodic reaction. Depending on the concentration of OH in the coating, amorphous silica (SiO₂) in the cation-exchange silica gel can be more or less partially dissolved into silicate ions (SiO₃²⁻). The generated SiO₃²⁻ ions react with iron ions at the coating/metal interface, thus forming a protective layer of iron silicate (Fe₂(SiO₃)₃); at the same time, cations released from the cation-exchange silica gel e.g. Ca²⁺ cations react with the dissolved SiO₃²⁻ ions so that a protective film of calcium silicate (CaSiO₃) is formed in the alkaline region of the metal interface. CaSiO₃ and Fe₂(SiO₃)₃ are deposited together to form a composite protective film layer at the metal interface. In addition, the cations e.g. Ca²⁺ cations released from the cation-exchange silica gel can interact with the dissociated phosphate and OH⁻ in the coating system to form calcium phosphate (Ca₃(PO₄)₂) and water molecules, thus forming a calcium phosphate barrier layer that prevents oxygen from approaching the surface of the metal substrate.

It can be seen that it is preferable to include cation exchange silica gel in the corrosion inhibiting composition, which acts as an enhancer to further enhance the anticorrosive effect of the anti-rust particles containing at least one phosphate compound of lithium.

In some embodiments of the present application, said cation-exchange silica gel is porous. It is advantageous to have a cation exchange silica gel having a porous structure because the cation exchange silica gel having such a structure can carry a larger amount of cations, thus facilitating the formation of the above mentioned protective film.

In some embodiments of the present application, the cation-exchange silica gel is basic or neutral, having a pH of at least 7.0. Preferably, the pH of the cation-exchange silica gel is in the range of 7.0 to 11.5, more preferably, in the range of 7.5 to 11.2. In one embodiment of the present application, the pH of the cation-exchange silica gel is in the range of 7.5 to 9.0. In another embodiment of the present application, the pH of the cation-exchange silica gel is in the range of 9.0 to 11.2.

In some embodiments of the present application, said at least one cation-exchange silica gel comprises magnesium ion-exchange silica gel, barium ion-exchange silica gel, aluminum ion-exchange silica gel, and calcium ion-exchange silica gel. In a preferred embodiment of the present application, said at least one cation-exchange silica gel comprises a calcium-ion-exchange silica gel.

Preferably, said cation-exchange silica gel is present in an amount of 0.5% by weight, preferably 1.0% by weight or more, but not more than 5.0% by weight, relative to the total weight of component A. In a specific embodiment of the present application, said component A comprises from about 1.0 to 2.5% by weight of the cation-exchange silica gel, or from about 1.5 to 2.5% by weight of the cation-exchange silica gel, or from about 1.5 to 2.0% by weight of the cation-exchange silica gel, or from about 1.0 to 2.0% by weight of the cation-exchange silica gel, or from about 1.5% by weight to 1.8% by weight of the cation-exchange silica gel, relative to the total weight of component A.

In some embodiments according to the present application, the corrosion inhibiting composition contained in the chromium-free anticorrosive coating composition may optionally comprises one or more other corrosion inhibitors. However, it is preferable that the corrosion inhibiting composition contained in the chromium-free anticorrosive coating composition is substantially free of other corrosion inhibitors, more preferably completely free of other corrosion inhibitors. It was particularly surprisingly discovered by the inventors of the present application that, in addition to the above-mentioned anti-rust particles containing at least one phosphate compound of lithium and cation exchange silica gel, the incorporation of other chromium-free corrosion inhibitors commonly used in the art, such as aluminum tripolyphosphate and organic corrosion inhibitors, into the corrosion inhibiting composition according to the present application would adversely affect the anticorrosive properties of the resulting coating, which was unforeseen prior to the present application.

In some embodiments according to the present application, the corrosion inhibiting composition comprises, relative to the total weight of said corrosion inhibiting composition, at least 70% by weight, at least 75% by weight, at least 80% by weight, at least 85% by weight, at least 95% by weight or even 100% by weight of the anti-rust particles containing at least one phosphate compound of lithium.

In some embodiments according to the present application, preferably, said component A, relative to the total weight of said component A, comprises from about 6% by weight to about 15% by weight of the corrosion inhibiting composition. In some embodiments of the present application, said component A, relative to the total weight of said component A, comprises at least about 6% by weight, or at least about 6.5% by weight, or at least about 7% by weight, or at least about 8% by weight of the corrosion inhibiting composition. In the above embodiments of the present application, said component A, relative to the total weight of said component A, comprises less than about 15% by weight, or less than about 13% by weight, or less than about 12% by weight of the corrosion inhibiting composition.

In some embodiments according to the present application, the chromium-free anticorrosive coating composition is a two-component coating composition comprising a component A and a component B, said component A comprising a film-forming composition, a corrosion-inhibiting composition, an optional carrier and additional additives, and said component B comprising a curing agent. Prior to construction, said component A is mixed with said component B and then applied.

In some other embodiments according to the present application, said chromium-free anticorrosive coating composition is a one-component coating composition comprising component A, said component A comprising a film-forming composition, a corrosion-inhibiting composition, an optional carrier and additional additives. In these embodiments, said film-forming composition may be cured to form a film by, for example, self-crosslinking.

In embodiments according to the present application, the film-forming composition refers to a composition that constitutes the main body of a coating formed from the chromium-free anticorrosive coating composition, which comprises a resin component and may also comprise, independently or additionally, an inorganic silicates film-forming material.

In some embodiments according to the present application, the above-mentioned inorganic silicates film-forming material is used for providing a film-forming composition for the chromium-free anti-corrosive coating composition. In one aspect, the inorganic silicates film-forming material functions as a binder which provides adhesion of coating to a substrate, and holds together other components, such as fillers, of the coating composition to impart basic cohesive strength to the paint film forming from the coating composition of the present disclosure. The chromium-free anticorrosive coating composition using this inorganic silicates as a film-forming substance has an additional beneficial effect of abrasion resistance, which has attracted attention in recent years.

In some embodiments according to the present application, the above-mentioned resin component is used for providing a film-forming composition for the chromium-free anti-corrosive coating composition. The resin component may be for example at least one selected from epoxy resins, chlorinated resins, polyaspartates, alkyd resins, phenolic resins, polyurethanes, polysiloxanes, polyesters, and acrylics resin. In a currently preferred embodiment, the resin component may be at least one of selected from epoxy resin, polyester and acrylics resin. In a currently more preferred embodiment, the resin component may be selected from epoxy resin.

In a preferred embodiment according to the present application, the resin component is epoxy resin. The term “epoxy resin” as used herein refers to a polymer or oligomer containing two or more epoxy groups in one molecule. Preferably, the epoxy resin contains at most four epoxy groups in one molecule. More preferably, the epoxy resin contains two or three epoxy groups in one molecule. According to some embodiments of the present application, the epoxy resin may have an epoxy equivalent varying over a wide range, wherein the epoxy equivalent is the mass of an epoxy resin containing 1 mole of epoxy group. For example, the epoxy resin may comprise a low epoxy equivalent epoxy resin, a high epoxy equivalent epoxy resin or its combination thereof. As used herein, the epoxy resin having an epoxy equivalent between 400 and 700 g/eq, preferably between 450 and 550 g/eq is known as a low epoxy equivalent epoxy resin. The epoxy resin having a higher epoxy equivalent, such as having an epoxy equivalent greater than 800 g/eq, is known as a high epoxy equivalent epoxy resin. Preferably, the high epoxy equivalent epoxy resin may have an epoxy equivalent in the range of 900 g/eq to 2500 g/eq. In some embodiments, the high epoxy equivalent epoxy resin may have an epoxy equivalent in the range of 850 g/eq to 1200 g/eq. In some embodiments, the high epoxy equivalent epoxy resin may have an epoxy equivalent in the range of 1400 g/eq to 2500 g/eq, for example, in the range of 1600 to 1800 g/eq, or in the range of 1700 to 2200 g/eq.

Suitable epoxy resin comprises, for example diglycidyl ether of polyhydric phenol, such as diglycidyl ether of resorcinol, diglycidyl ether of catechol, diglycidyl ether of hydroquinone, diglycidyl ether of bisphenol A, diglycidyl ether of bisphenol F, diglycidyl ether of bisphenol S, diglycidyl ether of tetramethyl bisphenol; diglycidyl ether of polyalcohol, such as diglycidyl ether of aliphatic diglycol and diglycidyl ether of polyether glycol, for example diglycidyl ether of C₂₋₂₄ alkylene glycol, diglycidyl ether of poly(ethylene oxide) glycol or diglycidyl ether of poly(propylene oxide) glycol; or polyglycidyl ether of novolack resin, such as polyglycidyl ether of phenol-formaldehyde resin, polyglycidyl ether of alkyl substituted phenol-formaldehyde resin, polyglycidyl ether of phenol-hydroxyl benzaldehyde resin, or polyglycidyl ether of cresol-hydroxyl benzaldehyde resin; or the combination thereof.

According to some embodiments of the present disclosure, the epoxy resin is diglycidyl ether of polyhydric phenol, especially preferably having the structure of formula (I):

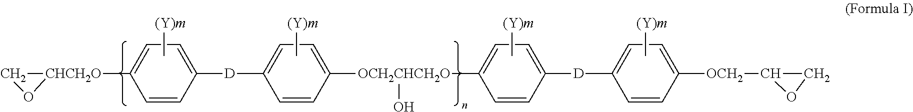

wherein
D each represents —S—, —S—S—, —SO—, —SO₂—, —CO₂—, —CO—, —O— or C₁ to C₁₀ alkylene, preferably C₁ to C₁₀ alkylene, more preferably C₁ to C₃ alkylene, such as —CH₂— or —C(CH₃)₂—,
Y each independently represents halogen, such as F, Cl, Br, or I, or optionally substituted monovalent C₁ to C₁₀ hydrocarbon group, such as optionally substituted methyl, ethyl, vinyl, propyl, allyl or butyl;
m each independently represents 0, 1, 2, 3 or 4, and
n represents an integer from 0 to 4, such as 0, 1, 2, 3 or 4.

More preferably, the epoxy resin is bisphenol A epoxy resin, bisphenol S epoxy resin or bisphenol F epoxy resin having the structure of formula (I) in which D represents —C(CH₃)₂—, —SO₂— or —CH₂— respectively, m represents 0, and n represents an integer from 0 to 4.

Most preferably, the epoxy resin is bisphenol A epoxy resin having the structure of formula (I) in which D represents —C(CH₃)₂—, m represents 0, and n represents an integer from 0 to 4.

The epoxy resin as disclosed herein may be prepared by the epichlorohydrin technology which is well-known by those skilled in the art, for example. Alternatively, as an example of epoxy resin, any suitable commercial product may be used, for example E55, E51, E44, or E20 available from Kaiping Resin Company, Shanghai, China; or those in the form of an aqueous epoxy resin emulsion, such as Allnex 387 from Allnex, 3907 from Huntsman, 900 and 1600 from Nanya, or EPIKOTE™ Resin 6520 from Hexion. Preferably, the aqueous epoxy resin emulsion has a solid content of 40-60% by weight.

In another preferred embodiment according to the present application, the resin component comprises a polyester resin. The term “polyester resin” is used herein to refer to a liquid polyester resin made by condensation polymerization of a polyol and a polyacid or anhydride together. Representative polyols include glycerol, pentaerythritol, sorbitol, trimethylolpropane, ethylene glycol, diethylene glycol, propylene glycol, dipropylene glycol, and other polyols known to those of ordinary skill in the art to be used in the preparation of polyester resins. Representative polyacids or anhydrides include dibasic acids or anhydrides such as phthalic acid and its anhydride, isophthalic acid, terephthalic acid, maleic acid, fumaric acid, adipic acid, sebacic acid, and the like; ternary acids such as trimellitic acid; and other polyacids or anhydrides known to those of ordinary skill in the art for use in the preparation of polyester resins.

As noted above, polyester resins can be prepared by suitable preparation methods known to those of ordinary skill in the art, or can be obtained from any suitable commercially available product. As commercial examples of polyester resins, polyester resins such as commercially available grades SH970, SH973, SH974, SN800 and SN908 from DSM in the Netherlands, or grades ES-300, ES-410, ES-450, ES-901, ES-910, ES-955, ES-960 and ES-980 from SK Chemical, or grades L205, L210, L411, LH820, LH833, LH818 and LH910 purchased from Degussa may be used.

In another embodiment according to the present application, the resin component comprises an acrylics resin. The acrylics resin suitable for use in the present application may be a water-dispersible acrylics resin, which may be made using techniques known to those of ordinary skill in the art. For example, the acrylics resin may be a copolymer of various ethylenically unsaturated compounds. Examples of suitable ethylenically unsaturated monomers include vinyl and vinylidene monomers such as styrene, alpha-methylstyrene, o- and p-chlorostyrene, o-, m- and p-methylstyrene, p-tert-butylstyrene, acrylic acid, (meth)acrylonitrile, acrylate and methacrylate having 1 to 8 carbon atoms such as ethyl acrylate, methyl acrylate, n- or isopropyl acrylate n-butyl acrylate, 2-ethylhexyl acrylate, 2-ethylhexyl methacrylate, isooctyl acrylate, methyl methacrylate, ethyl methacrylate, butyl methacrylate and isooctyl methacrylate; diesters of fumaric, itaconic or maleic acid with an alcohol component having 4 to 8 carbon atoms; (meth)acrylamide; vinyl esters of alkyl monocarboxylic acids having 2 to 5 carbon atoms such as vinyl acetate or vinyl propionate and hydroxyalkyl esters of acrylic or methacrylic acid where the hydroxyalkyl residue has 2 to 4 carbon atoms, such as 2-hydroxyethyl acrylate or methacrylate, 2-hydroxypropyl acrylate or methacrylate, 4-hydroxybutyl acrylate or methacrylate, trimethylolpropane monoacrylate or methacrylate or pentaerythritol monoacrylate or methacrylate. Mixtures of these monomers are also suitable.

As an example of an acrylic resin, any conventional acrylics resin can be used, such as acrylate resin 476706 commercially available from SWIMC.

The above mentioned resin component is used for providing a film-forming composition for the chromium-free anti-corrosive coating composition. In one aspect, the resin component functions as a binder which provides adhesion of coating to a substrate, and holds together other components, such as fillers, of the coating composition to impart basic cohesive strength to the paint film forming from the coating composition of the present disclosure. In the other aspect, the resin component has good reactivity with a curing agent if any, thereby providing a coating having higher mechanical strength.

Preferably, the chromium-free anti-corrosive coating composition comprises about 30% to about 70% by weight of the film-forming composition relative to the total weight of Component A. In some embodiments of the present application, the chromium-free anti-corrosive coating composition comprises at least about 32% by weight, or at least about 34% by weight, or at least about 40% by weight, or at least about 45% by weight of the film-forming composition relative to the total weight of the Component A. In the above embodiment of the present application, the chromium-free anticorrosive coating composition comprises less than about 65% by weight, or less than about 60% by weight, or less than about 55% by weight of the film-forming resin composition relative to the total weight of the Component A.

If required, the chromium-free anticorrosive coating composition further comprises a curing agent for the resin component, the type of which depends on the nature of the resin component.

The epoxy resin-containing coating composition preferably comprises an aliphatic or aromatic amine curing agent, a polyamide curing agent, or a mercaptan-based curing agent. Suitable amine curing agents are aliphatic amines and their adducts (e.g. ANCAMINE 2021), phenalkamines, cycloalicyclic amines (e.g. ANCAMINE 2196), amidoamines (e.g. ANCAMIDE 2426), polyamides and their adducts, and their mixtures.

The coating composition containing amino and/or hydroxyl functional resin preferably adopts isocyanate and isocyanurate as curing agents. Suitable isocyanate curing agents are aliphatic, cycloaliphatic and aromatic polyisocyanates, such as trimethylene diisocyanate, 1,2-propylene diisocyanate, tetramethylene diisocyanate, 2,3-butylene diisocyanate, hexamethylene diisocyanate, octamethylene diisocyanate, 2,4-trimethylhexamethylene diisocyanate, 2,4,4-trimethylhexamethylene diisocyanate, dodecamethylene diisocyanate, 1,3-cyclopentylidene diisocyanate, 1,2-cyclohexylidene diisocyanate, 1,4-cyclohexylidene diisocyanate, 4-methyl-1,3-cyclohexylidene diisocyanate, meta- and p-phenylene diisocyanate, 1,3- and 1,4-bis(isocyanate methyl)benzene, 1,5-dimethyl-2,4-bis(isocyanate methyl)benzene, 1,3,5-triisocyanatebenzene, 2,4-toluene diisocyanate, 2,6-toluene diisocyanate, 2,4,6-toluene triisocyanate, α,α,α′,α′-tetramethyl o-, m- and p-xylylene diisocyanate, 4,4′-diphenylene diisocyanate methane, 4,4′-diphenylene diisocyanate, 3,3′-dichloro-4,4′-diphenylene diisocyanate, naphthalene-1,5-diisocyanate, isophorone diisocyanate, trans-vinylidene diisocyanate, and mixtures of the above-mentioned polyisocyanates. Adducts of the aforementioned polyisocyanates are also suitable, such as biuret, isocyanurate, allophonate, uretdione and mixtures thereof. Depending on the application, the above-mentioned isocyanates and their adducts may exist in the form of blocked or latent isocyanates.

In the two-component chromium-free anticorrosive coating composition according to the present application, the amount of curing agent used as Component B can be adjusted empirically by those skilled in the part based on the amount of component A, especially the amount of film-forming composition in component A. In some embodiments of the present application, the weight ratio of Component A and Component B as the curing agent may be 100:15, 100:23, 100:30 or other commonly used ratios of Component A and Component B in the art.

In embodiments according to the present application, the carrier is optional in the formulation of the chromium-free anticorrosive coating composition. In some embodiments according to the present application, the chromium-free anticorrosive coating composition does not contain a carrier and is present in the form of a powder coating composition. In some embodiments according to the present application, the chromium-free anticorrosive coating composition may include a carrier and is present in the form of a solvent-borne coating composition or an aqueous coating composition.

If present, the carrier comprises water, a water-miscible organic solvent, a water-immiscible organic solvent, or a combination thereof, thereby reducing the viscosity of the coating composition for application. The addition of organic solvents can increase the volatilization rate of the anticorrosive coating composition and accelerate the formation of the paint film. In some embodiments of the present application, the organic solvent includes ketones (such as acetone, methyl isopropyl ketone, methyl isobutyl ketone, and the like), alcohols (propanol, benzyl alcohol, and the like), esters (ethyl acetate, butyl acetate, and the like), aromatic hydrocarbons (toluene, xylene, and the like), aliphatic hydrocarbons (cyclopentane, cyclohexane, and the like) or any combination thereof.

In a preferred embodiment according to the present application, if present, the carrier may, for example, account for at least about 5% by weight, at least about 6% by weight, at least about 7% by weight, at least about 8% by weight, at least about 9% by weight, or at least about 10% by weight of the total weight of Component A. In a preferred embodiment according to the present application, if present, the carrier may, for example, account for at most about 15% by weight, at most about 14% by weight, at most about 13% by weight, or at most about 12% by weight of the total weight of Component A. Generally, the desired amount of the carrier is usually selected empirically based on the film-forming properties of the paint film.

In embodiments of the present application, the chromium-free anticorrosive coating composition may optionally further include commonly used additional additives. Suitable additional additives may include fillers, wetting and dispersing agents, defoamers, leveling agents, additional corrosion inhibitors, adhesion promoters, film forming aids, rheology modifiers, or any combination thereof.

The content of each of the above-mentioned optional ingredients is sufficient to achieve its intended purpose, but preferably, such content does not adversely affect the coating composition or the coating obtained therefrom. According to certain embodiments of the present application, the total amount of additional additives is in the range of about 0% to about 50% by weight, preferably in the range of about 0.1% to about 40% by weight relative to the total weight of Component A.

In a specific embodiment according to the present application, Component A of the chromium-free anticorrosive coating composition comprises, relative to the total weight of component A,
30-70% by weight of the film-forming composition;
6-15% by weight of the corrosion inhibiting composition;
0-15% by weight of the carrier; and
0-50% by weight of the additional additives, preferably 0.1-40% by weight of the additional additives.

In a more specific embodiment according to the present application, Component A of the chromium-free anticorrosive coating composition comprises, relative to the total weight of component A,
30-70% by weight of the film-forming composition;
5-20% by weight of the anti-rust particles;
0.5-5% by weight of the cation-exchange silica gel;
0-15% by weight of the carrier; and
0-50% by weight of the additional additives, preferably 0.1-40% by weight of the additional additives.

The anticorrosive coating composition of the present application can be prepared by any suitable mixing method known to those of ordinary skill in the art. For example, the coating composition can be made by adding the film-forming composition, the anti-rust particles containing phosphate compounds of lithium, the cation-exchange silica gel, the carrier (if any) and the additional additives (if any) to a container, and then stirring the resulting mixture uniformly, thereby forming the Component A. According to requirements, the curing agent as component B may exist as a single component or may be mixed with the above-mentioned components in the form of a mixture.

The chromium-free anticorrosive coating composition thus formed can be used as a primer in combination with a conventional topcoat, or can be used alone as a direct-to-metal coating composition to provide metal substrates with required anticorrosive properties. In some preferred embodiments according to the present application, the chromium-free anticorrosive coating composition is a primer. In the embodiments according to the present application, the chromium-free anticorrosive coating composition is an aqueous coating composition. Preferably, this aqueous coating composition is not only suitable for wet on wet system, but also for wet on dry system, and a two-component polyurethane may be used as a topcoat suitable for use with the primer.

As described above, the inventors of the present application surprisingly discovered that the anticorrosive coating composition as prepared can achieve excellent water resistance, more preferably excellent salt spray resistance and water resistance both when used as a primer or as a direct-to-metal coating.

In an embodiment according to the present application, when the above-mentioned coating composition is used as a direct-to-metal coating and applied to a sandblasted steel plate in a dry paint film thickness of 40 to 70 microns and cured, and the resulting paint film is scratched to form cross-shaped scratches so as to obtain a test sample, the test sample after being subjected to a salt spray test according to ASTM B117 or GB/T1771 for 500 hours or longer exhibits a stripping width on one side of 2 mm or less.

In an embodiment according to the present application, when the above-mentioned coating composition is used as a direct-to-metal coating and applied to a sandblasted steel plate in a dry paint film thickness of 40 to 70 microns and cured so as to obtain a test sample, the test sample after being immersed at an aqueous environment at room temperature for 500 hours or at an aqueous environment at a temperature of 40° C. for 12 days is substantially free of blistering, preferably completely free of blistering.

It was further surprisingly found by the inventors of the present application that using a wet-to-dry process or a wet-to-wet process, the combination of the anticorrosive coating composition prepared as above as a primer with a conventional topcoat (such as an aqueous polyurethane topcoat shows excellent resistances to salt spray and to water soaking, which is unexpected. As noted above, the wet-on-wet process refers to a coating process in which a second coat is applied before the first coat is completely dry. In the field of coatings, especially in the field of anticorrosive coatings, the wet-on-wet process is a more demanding coating process. It is well known that a topcoat usually reacts with a primer when the primer is not completely dry, resulting in a less dense crosslinking of the primer so that corrosion is easily to occur. However, it was particularly surprisingly found by the inventors of the present application that the anti-corrosive coating composition according to the present application is particularly suitable as a primer for a wet-on-wet system, which not only does not cause construction problems such as sagging and wrinkling, but also achieves excellent anticorrosive properties, which were difficult to expect prior to the present application. As an exemplary illustration, the wet-on-wet process includes, for example, the following steps: applying a primer, leveling it at room temperature for 15 minutes, spraying a topcoat, leveling it for more than 20 minutes, and then curing the coating at 60° C. for at least 12 hours. As an exemplary illustration, the wet-to-dry process includes, for example, the following steps: applying a primer, leveling it at room temperature for 15 minutes, curing it at 60° C. for 12 hours or more, and then spraying a topcoat, leveling it for more than 20 minutes, and then curing it at 60° C. for 12 hours or more, such as 20 hours or more.

In an embodiment according to the present application, when using a wet-to-dry process, the above-mentioned coating composition is used as a primer and applied to a sandblasted steel plate in a dry paint film thickness of 40 to 70 microns and cured, and a polyurethane topcoat is applied to the dried primer in a dry paint film thickness of 40 to 70 microns and cured, and the resulting paint film is scratched to form cross-shaped scratches so as to obtain a test sample, the test sample after subjecting to a salt spray test according to ASTM B117 or GB/T1771 for 500 hours or longer has a stripping width on one side of 3 mm or less, preferably of 2 mm or less.

In an embodiment according to the present application, when using a wet-to-wet process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured, and the resulting paint film is scratched to form cross-shaped scratches so as to obtain a test sample, the test sample after subjecting to a salt spray test according to ASTM B117 or GB/T1771 for 500 hours or longer, preferably 700 hours or longer, has a stripping width on one side of 3 mm or less, preferably of 2 mm or less.

In an embodiment according to the present application, when using a wet-to-dry process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured so as to obtain a test sample, the test sample after being immersed at an aqueous environment at room temperature for 500 hours and/or at an aqueous environment at a temperature of 40° C. for 18 days is substantially free of blistering, preferably completely free of blistering.

In an embodiment according to the present application, when using a wet-to-wet process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured so as to obtain a test sample, the test sample after being subjecting to soaking at an aqueous environment at room temperature for 500 hours and/or at an aqueous environment at a temperature of 40° C. for 18 days is substantially free of blistering, preferably completely free of blistering.

In another aspect, the present application provides an article comprising a metal substrate; and a coating formed of the chromium-free anticorrosive coating composition according to the present application which is directly applied to the metal substrate. As mentioned above, the chromium-free anticorrosive coating composition of the present application can be used as a primer or as a direct-to-metal coating. Therefore, in some embodiments of the present application, the article comprises a metal substrate; a primer layer formed of the chromium-free anticorrosive coating composition of the present application, which is directly coated on the metal substrate; and a topcoat formed from a conventional topcoat in the art (for example, a water-based polyurethane topcoat) applied over the primer. In other embodiments of the present application, the article comprises a metal substrate; and a coating formed of the chromium-free anticorrosive coating composition of the present application, which is directly coated on the metal substrate

As a metal substrate for manufacturing the article of the present application, any suitable metal substrate known in the art can be used. As an example, the metal substrate is one or more selected from steel, iron, aluminum, zinc, copper and their alloys.

According to the present application, the article can be prepared, for example, by the following steps: (1) providing a polished metal substrate; (2) using a coating and curing process to sequentially coat and form one or more chromium-free anticorrosive coating composition of the present application on the metal substrate to provide corrosion resistance for the metal substrate.

According to the present application, the metal articles thus obtained can be further treated with an additional anticorrosive topcoat, and can be used for the following end-use applications, including but not limited to refrigerated containers and unrefrigerated shipping containers (e.g., dry cargo containers) from suppliers or manufacturers including China International Marine Containers (CIMC), Graaff Transportsysteme Gmbh, Maersk Line and others that will be familiar to persons having ordinary skill in the art, chassis, trailers including semitrailers, rail cars, truck bodies, ships, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles, and the like.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### Examples

### Test Methods

### Salt Spray Resistance

According to needs, the anticorrosive coating composition was used as a primer or as a direct-to-metal coating and applied to a sandblasted steel plate in a dry paint film thickness of 40 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to a salt spray test according to ASTM B117 or GB/T1771 for 500 hours or more, and the stripping width of scratches on one side was measured. When the stripping width on one side after 500 hours of salt spray test exceeded 2 mm or the stripping width on one side after 700 hours of salt spray test exceeded 3 mm, the test sample was considered unqualified and had poor wet adhesion. When the stripping width on one side after the 500-hour salt spray test was 2 mm or less or the stripping width on one side after 700 hours of salt spray test was 3 mm or less, the test sample was considered to be qualified.

### Water Resistance

According to needs, the anticorrosive coating composition was used as a primer or as a direct-to-metal coating and applied to a sandblasted steel plate in a dry paint film thickness of 40 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to soaking at an aqueous environment at room temperature for 500 hours or at an aqueous environment at a temperature of 40° C. for 18 days and was observed whether there are blistering on the surface of the coating. If the test sample was subjected to soaking at an aqueous environment at room temperature for 500 hours or at an aqueous environment at a temperature of 40° C. for 18 days and there was blistering on the surface of the coating, the test sample was considered to be unqualified. If the test sample was subjected to soaking at an aqueous environment at room temperature for 500 hours or at an aqueous environment at a temperature of 40° C. for 18 days and there was no blistering on the surface of the coating, the test sample was considered to be qualified.

### Epoxy Resin-Based Anticorrosive Coating Composition

As shown in Table 1, the components of component A were mixed to obtain a mixture, which was then mixed with the curing agent as Component B to form the epoxy resin-based anticorrosive coating composition according to Examples 1 to 7 (Ex. 1-7) of the present application.

TABLE 1
Composition and amount of epoxy resin-based anticorrosive coating composition

| Raw materials/g | Ex.1 | Ex.2 | Ex.3 | Ex.4 | Ex.5 | Ex.6 | Ex.7 |
|---|---|---|---|---|---|---|---|
| Component A | | | | | | | |
| Epoxy resin | 44 | 44 | 44 | 44 | 44 | 44 | 44 |
| Anti-rust particles | 8 | 10 | 12 | 6.5 | 8.5 | 10.5 | 4.25 |
| Calcium ion exchange silica gel | — | — | — | 1.5 | 1.5 | 1.5 | 1.5 |
| Aluminum tripolyphosphate | — | — | — | — | — | — | 2.25 |
| Carrier | 12 | 12 | 12 | 12 | 12 | 12 | 12 |
| Additive | 6 | 6 | 6 | 6 | 6 | 6 | 6 |
| Filler | 30 | 28 | 26 | 30 | 28 | 26 | 30 |
| Total | 100 | 100 | 100 | 100 | 100 | 100 | 100 |
| Component B | | | | | | | |
| Epoxy resin curing agent-1 | 15 | 15 | 15 | 15 | 15 | 15 | 15 |
| Coating Performances | | | | | | | |
| Water resistance@40° C., | No | No | No | No | No | No | No |
| 18 days | blistering | blistering | blistering | blistering | blistering | blistering | blistering |
| Water resistance@ room | No | No | No | No | No | No | No |
| temperature, 500 hours | blistering | blistering | blistering | blistering | blistering | blistering | blistering |
| Salt spray resistance@502 | — | — | — | 1.84 | 1.89 | 2.00 | 1.56* |
| hours/mm | | | | | | | |
| Salt spray resistance@790 | — | — | — | 2.48 | 2.86 | 2.71 | — |
| hours/mm | | | | | | | |

*In example 7, the test sample was subjected to the salt spray resistance test for 320 hours.

### Anticorrosive Performance of Epoxy-Based Coating Composition

As shown in Examples 1-7, in the anticorrosive coating composition according to the present application, anti-rust particles containing phosphate compounds of lithium, a combination of the anti-rust particles and calcium ion-exchange silica gel, and a combination of the anti-rust particles, calcium ion-exchange type silica gel and aluminum tripolyphosphate were employed as a corrosion inhibiting composition. Then, an aqueous polyurethane topcoat was applied to the incompletely dried primer formed from the coating compositions of Examples 1-7 to form a topcoat. The resulting composite coatings were subjected to a water resistance test at 40° C. for 18 days and a water resistance test at room temperature for 500 hours, and/or a salt spray test according to ASTM B117 for at least 500 hours and 700 hours, respectively.

As can be seen from the results of Examples 1-6 in Table 1, in the formulation of the chromium-free anticorrosive coating composition, the use of a corrosion inhibiting composition comprising anti-rust particles containing at least one phosphate compound of lithium allowed the paint film formed therefrom to exhibit an excellent water resistance in which said corrosion resistance is demonstrated by the fact that the formed film did not blister after being subjected to soaking in an aqueous environment at 40° C. for 18 days or longer and in an aqueous environment at room temperature for 500 hours. Moreover, in the formulation of a chromium-free anticorrosive coating composition, the use of a corrosion inhibiting composition comprising anti-rust particles containing at least one phosphate compound of lithium and at least one cation exchange silica gel allowed the paint film formed therefrom to exhibit not only excellent water resistance in which said water resistance was demonstrated by the fact that the formed film did not blister after being subjected to soaking in an aqueous environment at 40° C. for 18 days or longer and after being subjected to soaking in an aqueous environment at room temperature for 500 hours, but also to exhibit excellent corrosion resistance in which said corrosion resistance was demonstrated by the fact that the formed film had a stripping width of no more than 2 mm on one side after being subjected to a salt spray test according to ASTM B117 for 500 hours.

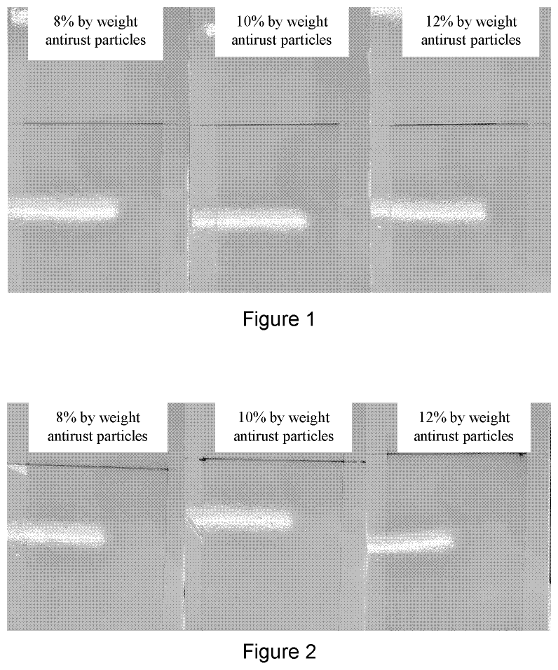

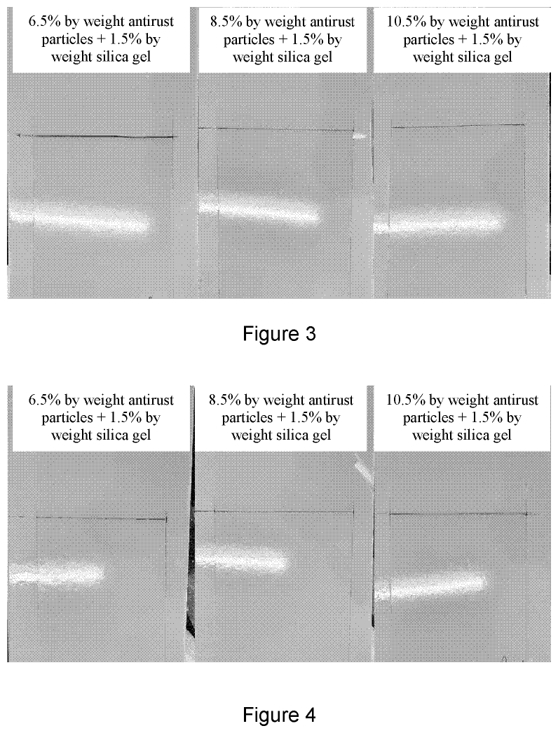

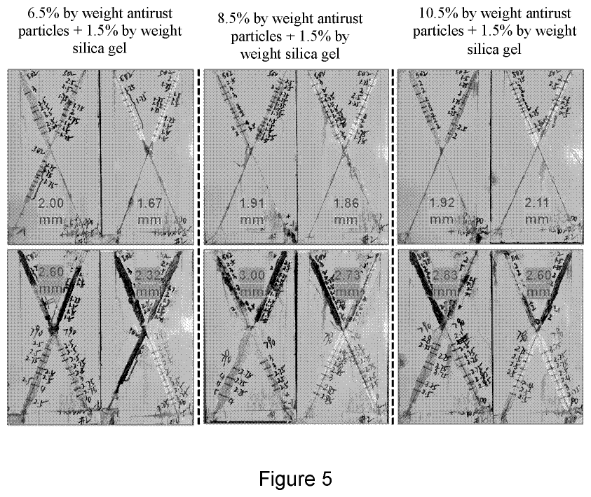

In order to show more visually the salt spray resistance and water resistance of the anticorrosive coating compositions according to the present application, photographs of the coatings formed from the anticorrosive coating compositions of Examples 1-6 after being subjected to water resistance test were shown in FIGS. 1-4 and photographs of the coatings formed from the anticorrosive coating compositions of Examples 4-6 after being subjected to the salt spray test were shown in FIG. 5. As shown in FIGS. 1-5, the coating formed from the chromium-free anticorrosive coating composition comprising the combination of anti-rust particles containing phosphate compounds of lithium and calcium ion-exchange silica gel according to the present application exhibited excellent salt spray resistance which was demonstrated by the fact that the coating had a limited stripping width on one side after being subjected to a salt spray test according to ASTM B117, none of which exceeded 3 mm, while exhibiting an excellent water resistance which was demonstrated by the fact that the coating did not blister and had a smooth surface after being subjected to soaking in water at 40° C. for 18 days or longer.

To further verify the anticorrosive effect of the anti-rust particles, a certain amount of aluminum tripolyphosphate was used to replace the same amount of anti-rust particles in Example 4 to form Example 7. Then, an aqueous polyurethane topcoat was applied to the incompletely dried primer formed from the coating composition of Example 7 to form a topcoat. The resulting composite coating was subjected to a salt spray test according to ASTM B117 for 320 hours and a water resistance test at 40° C. for 13 days and a water resistance test at room temperature for 600 hours. The results show that the coating of Example 7 had an excellent water resistance, but its salt spray resistance was significantly lower than that of the coating formed from the coating composition of Example 4. The coating formed from the coating composition of Example 4 had a one-sided stripping width of only 0.93 mm after being subjected to a salt spray test according to ASTM B117 for 320 hours, while the coating formed from the coating composition of Example 7 had a one-sided stripping width of 1.56 mm after being subjected to a salt spray test according to ASTM B117 for 320 hours. It can be seen that the anti-rust particles containing at least one phosphate compound of lithium are significantly better than other chromium-free corrosion inhibitors in terms of corrosion protection performance. In other words, in the corrosion inhibiting composition of the present application, the anti-rust particles containing at least one phosphate compound of lithium itself can have excellent anticorrosive performance, and water resistance, even without the need of compounding with other conventional anticorrosive substances to enhance its anticorrosive performance. This innovation is unprecedented.

While the present disclosure has been described with respect to a number of embodiments and examples, those skilled in the art, having benefit of this invention, will appreciate that other embodiments can be devised which do not depart from the scope of the present disclosure as disclosed herein.

What is claimed is:

1-22. (canceled)

23. A chromium-free anticorrosive coating composition, comprising:
Component A comprising
a film-forming composition, a corrosion inhibiting composition;
optional carriers;
and additional additives, wherein the corrosion inhibiting composition comprises
anti-rust particles containing at least one phosphate compound of lithium and having a lithium content of at least 1.0% by weight; and optionally
Component B comprising a curing agent.

24. The chromium-free anticorrosive coating composition according to claim 23, wherein the anti-rust particles have a lithium content of at least 5.0% by weight or more.

25. The chromium-free anticorrosive coating composition according to claim 23, wherein the anti-rust particles further comprise one or more of aluminum, calcium, iron, magnesium, manganese, strontium, and nickel element.

26. The chromium-free anticorrosive coating composition according to claim 23, wherein the anti-rust particles further comprise silicon element.

27. The chromium-free anticorrosive coating composition of claim 23, wherein the anti-rust particles are powders having a micron scale and having a particle size of less than 50 microns.

28. The chromium-free anticorrosive coating composition of claim 23, wherein the at least one phosphate compound of lithium has a spatially stable crystalline structure.

29. The chromium-free anticorrosive coating composition according to claim 23, wherein the anti-rust particles are derived from phosphorus-lithium-aluminum fillers.

30. The chromium-free anticorrosive coating composition of claim 23, wherein relative to the total weight of Component A, the anti-rust particles are present in an amount of 5% by weight or more but not more than 20% by weight.

31. The chromium-free anticorrosive coating composition of claim 23, wherein the corrosion inhibiting composition further comprises at least one cation exchange silica gel.

32. The chromium-free anticorrosive coating composition of claim 31, wherein the at least one cation exchange silica gel is porous.

33. The chromium-free anticorrosive coating composition of claim 31, wherein the at least one cation exchange silica gel comprises one or more of magnesium ion exchange silica gel, barium ion exchange silica gel, aluminum ion exchange silica gel and calcium ion exchange silica gel, preferably calcium ion exchange silica gel.

34. The chromium-free anticorrosive coating composition of claim 31, wherein, relative to the total weight of the component A, the at least one cation exchange silica gel is present in an amount of 0.5% by weight or more but not more than 5% by weight.

35. The chromium-free anticorrosive coating composition of claim 23, wherein the corrosion inhibiting composition is alkaline.

36. The chromium-free anticorrosive coating composition of claim 23, wherein the film-forming composition comprises at least one of inorganic silicates, epoxy resin, chlorinated resin, polyaspartate, alkyd resin, phenolic resin, polyurethane, polysiloxane, polyester resin, and acrylic resin, preferably at least one of epoxy resin, polyester resin, and acrylic resin.

37. The chromium-free anticorrosive coating composition of claim 23, wherein the carrier comprises water, a water-miscible organic solvent, a water-immiscible organic solvent, or a combination thereof.

38. The chromium-free anticorrosive coating composition of claim 23, wherein the chromium-free anticorrosive coating composition is an aqueous coating composition.

39. The chromium-free anticorrosive coating composition of claim 23, wherein the chromium-free anticorrosive coating composition is a solvent-based coating composition.

40. The chromium-free anticorrosive coating composition of claim 23, wherein the chromium-free anticorrosive coating composition is a powder coating composition.

41. The chromium-free anticorrosive coating composition of claim 23, wherein, relative to the total weight of Component A, the Component A comprises:
30-70% by weight of the film-forming composition;
6-15% by weight of the corrosion inhibiting composition;
0-15% by weight of the carrier; and
0-65% by weight of the additional additives.

42. An article comprising
a metal substrate selected from steel, iron, zinc, copper, aluminum, and alloys thereof; and
a coating formed from the chromium-free anticorrosive coating composition of claim 23 directly applied to the metal substrate.
